(19) United States
(12) Patent Application Publication
(10) Pub. No.: US 2015/0007962 A1
(43) Pub. Date: Jan. 8, 2015

(54) BEVERAGE COOLING DEVICE AND BEVERAGE SUPPLYING SYSTEM USING COOLING DEVICE

(71) Applicant: Winix Inc., Siheung-si (KR)

(72) Inventor: Hee-Jong Yoon, Siheung-si (KR)

(21) Appl. No.: 14/376,031

(22) PCT Filed: Dec. 11, 2012
(86) PCT No.: PCT/KR2012/010741

§ 371 Date: Jul. 31, 2014

(30) Foreign Application Priority Data
Oct. 18, 2012 (KR) 10-2012-0116253

(51) Int. Cl. B67D 7/80; B67D 7/84

(52) U.S. Cl. CPC B67D 7/80; B67D 7/84
USPC 165/63; 62/440; 62/132

(57) ABSTRACT

A beverage cooling device capable of improving cooling efficiency is disclosed.

The beverage cooling device includes: a beverage storing tank having an inlet through which a new beverage is injected and an outlet through which a cooled beverage is discharged;

a cooling unit for cooling a beverage supplied to the beverage storing tank by forming a frozen layer on an inner side wall surface of the beverage storing tank; a beverage flow guide unit provided in the beverage storing tank and increasing cooling efficiency by increasing an area which is in contact with the frozen layer while the beverage injected from the inlet is moved to the outlet; and

a passage securing unit preventing a passage through which the beverage is movable from being blocked by the frozen layer formed to be expanded to the beverage flow guide unit.

### CROSS-REFERENCE TO RELATED APPLICATION

This application claims priority to and the benefit of Korean Patent Application No. 10-2012-0116253 filed in the Korean Intellectual Property Office on Oct. 18, 2012, the entire contents of which are incorporated herein by reference.

### BACKGROUND OF THE INVENTION

(a) Field of the Invention

The present invention relates to a beverage cooling device. More particularly, the present invention relates to a beverage cooling device capable of securing a flow path in which a cooled beverage may be moved while improving cooling efficiency by sequentially cooling a beverage which is supplied from a beverage storing tank or a water pipe to thereby prevent a beverage which is first supplied and a beverage which is supplied later from being mixed with each other, and a beverage supplying system using the same.

(b) Description of the Related Art

In general, a beverage cooling device is a device which is installed in a water purifier receiving and purifying a tap water, a hot and cool water dispenser, or the like supplying a mineral water which is put in a certain container and is sold to cool the beverage to a predetermined temperature and supply it to a user.

In addition, when soft drink or liquor such as draft beer is taken out to a predetermined amount and sold in shops, the soft drink or the liquor has been sold by cooling it to a predetermined temperature by using the cooling device.

As such, in order to cool liquid such as the water, the soft drink, the liquor, or the like to the predetermined temperature, a storing tank for storing the beverage and a cooling device for cooling the beverage supplied from the storing tank are demanded.

The storing tank is provided with an inlet through which the beverage may be injected and an outlet for discharging the beverage stored in the storing tank to the outside, where the beverage stored in the beverage storing tank is cooled to the predetermined temperature by the cooling device.

A cock may be installed in the outlet to discharge the beverage stored in the beverage storing tank, and if a certain amount of beverage stored in the beverage storing tank is used, a new beverage as much as the used amount is supplied to the beverage storing tank through the beverage inlet.

In the beverage cooling device according to the related art as described above, if the beverage is injected into the beverage storing tank, the liquid which was early cooled and a beverage which was not cooled are mixed with each other in the beverage storing tank, thereby increasing a temperature of the cooled beverage within the beverage storing tank as much as a temperature of the beverage which was not cooled.

This has become one factor causing cooling efficiency within the beverage storing tank to be degraded.

The cooling device of the water purifier for allowing the liquid supplied to the beverage storing tank and a liquid stored in a liquid storing tank not to be mixed with each other has been disclosed in Korean Patent Laid-Open Publication No. 10-2002-0021228.

According to the cooling device disclosed in Korean Patent Laid-Open Publication No. 10-2002-0021228, a cooling coil in which a refrigerant is circulated is installed around a cooling box and a spiral guide plate is installed in the cooling box, such that a water injected into the cooling box is descended along the spiral guide plate to prevent it from being mixed a water which was present in the cooling box, thereby improving the cooling efficiency.

However, since the cooling device disclosed in Korean Patent Laid-Open Publication No. 10-2002-0021228 has the cooling coil installed around the cooling box, the water in the cooling box is frozen and an ice layer is formed by a cooling action by the cooling coil.

The ice layer becomes gradually thick as time goes on, and particularly, if the water in the cooling box is not discharged, the ice layer becomes thicker. As a result, in the case in which the above-mentioned state continues, a portion or all of an inner portion of the cooling box is frozen, thereby making it impossible to discharge the water in the cooling box to the outside.

In addition, since the cooling device disclosed in Korean Patent Laid-Open Publication No. 10-2002-0021228 has a structure in which an upper part of the cooling box is formed by an opening part and an injection part supplying the water to the cooling box is seated on the opening part, bacteria, pollution sources, and the like may be injected into the cooling box through a gap of the opening part.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a beverage cooling device and a beverage supplying system using the same having advantages of maximizing cooling efficiency by allowing a cooled liquid in a beverage storing tank and an uncooled beverage which is injected into the beverage storing tank to sequentially flow into an outlet while not being mixed with each other to guide a cooled beverage to be discharged and the uncooled beverage to be cooled, allowing a beverage to be used by securing a flow path within a liquid storing tank even in the case in which the cooled liquid is frozen, and preventing bacteria, pollution sources, and the like from being injected into the liquid storing tank by the liquid storing tank which is formed in a sealed type.

An exemplary embodiment of the present invention provides a beverage cooling device including: a beverage storing tank having an inlet through which a new beverage is injected and an outlet through which a cooled beverage is discharged; a cooling unit cooling a beverage supplied to the beverage storing tank by forming a frozen layer on an inner side wall surface of the beverage storing tank; a beverage flow guide unit provided in the beverage storing tank and increasing cooling efficiency by increasing an area which is in contact with the frozen layer while the beverage injected from the inlet is moved to the outlet; and a passage securing unit preventing a passage through which the beverage is movable from being blocked by the frozen layer formed to be expanded to the beverage flow guide unit.

The cooling unit may include a compressor compressing a refrigerant into a high temperature and high pressure state, a condenser converting the compressed evaporated refrigerant into a liquefied state, an expansion valve decreasing a pressure of the condensed refrigerant to facilitate evaporation of the condensed refrigerant, and a cooling pipe receiving the refrigerant from the expansion valve to thereby cool the beverage storing tank.

The passage securing unit may include a heating unit heating the beverage flow guide unit.

The beverage flow guide unit may include a support member extended from an upper side of an inner portion of the beverage storing tank to a lower side thereof, and a spiral plate provided in a spiral shape along an outer circumferential surface of the support member.

The heating unit may be installed to be inserted into a center of the support member and prevent a freezing around the support member.

The beverage storing tank may be further provided with a water temperature sensing sensor sensing a water temperature in the beverage storing tank and a controlling unit receiving water temperature data transmitted from the water temperature sensing sensor and actuating the passage securing unit or stopping the actuation of the passage securing unit.

Another embodiment of the present invention provides a beverage supplying system including: a beverage supplying source; a filter unit filtering foreign materials which are mixed in a beverage supplied from the beverage supplying source; a beverage storing tank temporarily storing a beverage supplied from the filter unit; a cooling unit cooling a beverage supplied to the beverage storing tank by forming a frozen layer on an inner side wall surface of the beverage storing tank; a beverage flow guide unit provided in the beverage storing tank and increasing cooling efficiency by increasing an area which is in contact with the frozen layer while the beverage injected from an inlet is moved to an outlet; and a passage securing unit preventing a passage through which the beverage is movable from being blocked by the frozen layer formed to be expanded to the beverage flow guide unit.

In the beverage cooling device according to an exemplary embodiment of the present invention, since the passage through which the beverage may flow may be secured by the passage securing unit even in the case in which the beverage present in the beverage storing tank is frozen, the cooled beverage may be always used.

In addition, since the beverage which is injected into the beverage storing tank may not be mixed with the early cooled beverage and be sequentially discharged through the outlet, the cooling efficiency of the beverage may be improved.

Further, since the beverage storing tank has the structure in which it is blocked from the outside, it is possible to prevent the invasion of bacteria from the outside.

### BRIEF DESCRIPTION OF THE DRAWINGS

FIG. 1 is a drawing showing a beverage supplying system including a beverage cooling device according to an exemplary embodiment of the present invention.

FIG. 2 is a drawing for describing a freeze cycle applied to the cooling device according to the present invention.

FIG. 3 is a cross-sectional side view of the cooling device according to an exemplary embodiment of the present invention.

FIG. 4 is a drawing showing a beverage supplying system including a beverage cooling device according to another exemplary embodiment of the present invention.

### DETAILED DESCRIPTION OF THE EMBODIMENTS

Hereinafter, a beverage cooling device according to an exemplary embodiment of the present invention and a beverage supplying system using the same will be described in more detail with reference to the accompanying drawings.

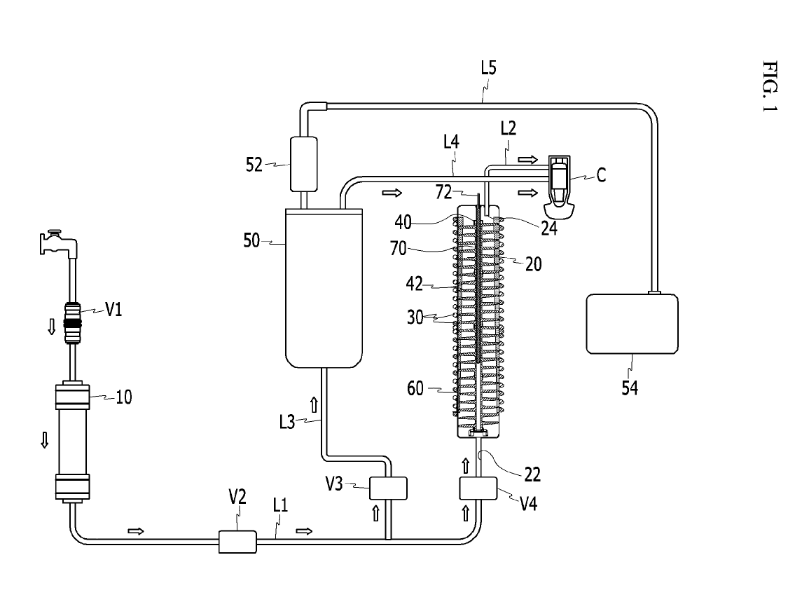

As shown in FIG. 1, a beverage cooling device and a beverage supplying system using the same according to a first exemplary embodiment of the present invention may be used as a cooling device for a water purifier, a hot and cool water dispenser, liquor, or the like, and FIG. 1 shows a case in which the beverage cooling device is used for the water purifier.

The beverage supplying system according to the present invention includes a filter unit 10 purifying a beverage supplied from a beverage supplying source S, a beverage storing tank 20 storing the purified beverage discharged through the filter unit 10, and a cooling pipe 30 provided to an outer circumference of the beverage storing tank 20.

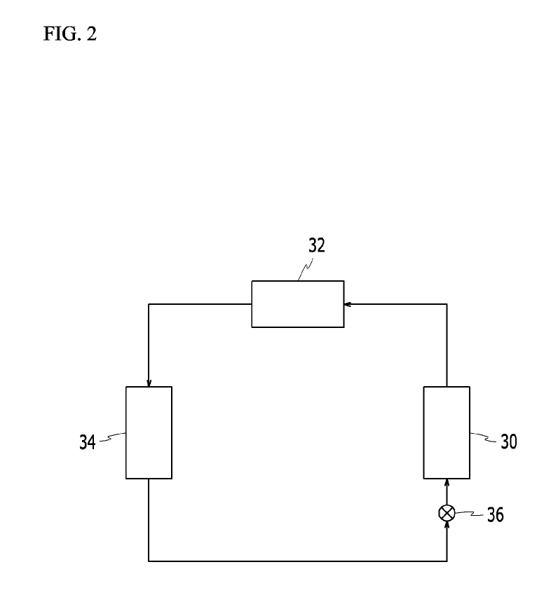

As shown in FIG. 2, the cooling pipe 30 is a component of a typical refrigerating system.

The cooling pipe 30 has a structure in which it is spirally wound on the outer circumference of the beverage storing tank 20. As shown in FIG. 2, a typical refrigerating cycle includes a compressor 32 compressing a refrigerant into a high temperature and high pressure gas, a condenser 34 receiving the compressed refrigerant in an evaporated state from the compressor 32 and converting the compressed refrigerant into a liquefied state, an expansion valve 36 decreasing a pressure of the condensed refrigerant to facilitate evaporation of the condensed refrigerant, and an evaporator decreasing a temperature by receiving the refrigerant from the expansion valve 36 and absorbing ambient heat. The cooling pipe 30 means the evaporator.

If a check valve V1 allowing the beverage to flow only in one direction is installed between the beverage supplying source S and the filter unit 10, the flow of the beverage in one direction may be stably maintained.

A pipe line L1 which is connected from the beverage supplying source S to supply the beverage is extended to an inlet 22 of the beverage storing tank 20 and another pipe line L2 for supplying a cooled beverage to a user is extended from an outlet 24 of the beverage storing tank 20. An end of the pipe line L2 is installed with a cock C having a general structure.

Another pipe line L3 is connected to the pipe line L1 to enable the beverage to be supplied to a hot water storing tank 50, which is connected to the cock C through another pipe line L4 to supply a hot water to the user.

All heating devices of a scheme capable of heating the beverage in the tank by generally using a heater may be used in the hot water storing tank 40.

Another pipe line L5 is connected to an upper portion of the hot water storing tank 40 and the pipe line L5 is connected to an auxiliary tank 42 for temporarily storing an expanded beverage when the beverage in the hot water storing tank 40 is expanded by a heating action. In the case in which the beverage is expanded to be in excess of capacity of the auxiliary tank 42, a water tank 44 may be installed at an end portion of the pipe line L5, as a unit for discharging the beverage.

Each of the pipe lines L1 and L3 is installed with each of solenoid valves V3 and V4 for allowing or blocking the supplying of the beverage into the beverage storing tank 20 and the hot water storing tank 40.

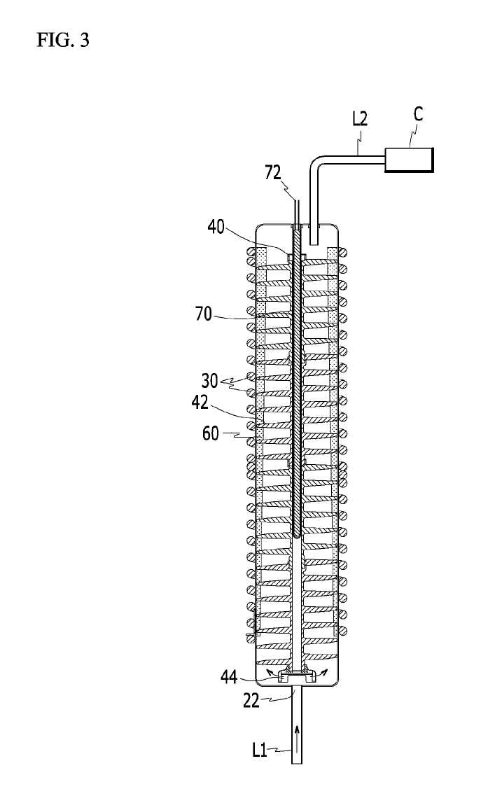

As shown in FIG. 3, a frozen layer 50 is formed in the beverage storing tank 20 by a cooling action of the cooling pipe 30 wound on the outer circumference of the beverage storing tank 20, such that a cold beverage may be provided to the user. Here, a beverage flow guide unit 60 is provided in the beverage storing tank 20, where the beverage flow guide unit 60 may increase cooling efficiency by widening a freezing area in which the frozen layer 50 and the beverage in the beverage storing tank 20 may be in contact with each other and increasing time in which the beverage is in contact with the frozen layer.

The beverage flow guide unit 60 includes a support member 70 and a spiral plate 72 having a certain area and wide and formed in a spiral shape on an outer circumference of the support member 70.

An outer circumferential surface of the spiral plate 72 may be preferably formed to have a size of a degree capable of being in contact with an inner circumferential surface of the beverage storing tank 20.

When the frozen layer 50 is formed on the inner circumferential surface of the beverage storing tank 20 by a heat exchanging action which is performed by the cooling pipe 30, the frozen layer 50 covers the outer circumferential surface of the spiral plate 72. An inner circumferential surface of the frozen layer 50 becomes a passage through which the beverage may flow.

In the case in which the frozen layer 50 is expanded to the beverage flow guide unit 60 to freeze the support member 70, a flow path through which the beverage may pass is closed. Here, a passage securing unit 80 for preventing the flow path through which the beverage may move from being closed is provided in the beverage storing tank 20.

The passage securing unit 80 according to an exemplary embodiment of the present invention does not allow the frozen layer 50 to be formed around the support member 70, thereby securing the passage of the beverage.

For this purpose, according to the present exemplary embodiment, an electrical heater H which is buried in a length direction of the support member 70 radiates heat, thereby preventing the freezing around the support member 70.

In order to bury the electrical heater H in the support member 70, a hole 74 for inserting the electrical heater H into the support member 70 is punched in the support member 70.

In order to prevent the beverage injected into the beverage storing tank 20 from being injected into the hole 74, a lower end portion of the support member 70 is provided with a cap 76.

The cap 76 blocks an injection of the beverage into the hole 74 which is punched in the support member 70. However, a hole 78 is formed in a side wall of the cap so that the beverage may be injected into the beverage storing tank 20 through the pipe line L1.

A beverage temperature sensing sensor 82 for sensing a temperature of the beverage is installed on an inner side of the beverage storing tank 20, so that the temperature of the beverage in the beverage storing tank 20 may be sensed in real time, and a temperature signal sensed by the sensor 82 is transmitted to a controlling unit 84. Accordingly, in the case in which the temperature of the beverage transmitted from the sensor 82 is a set temperature or more, the controlling unit 84 blocks a current supplied to the electrical heater H. The above-mentioned technical content may prevent the cooling efficiency from being degraded due to a temperature increase in the beverage storing tank 20.

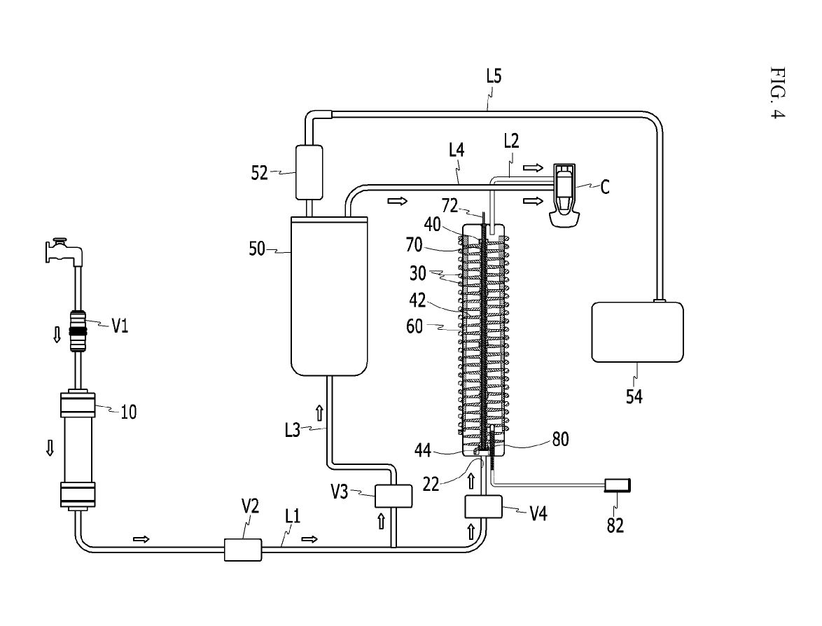

FIG. 4 shows a beverage supplying system according to another exemplary embodiment of the present invention. A difference between the system according to another exemplary embodiment and the system as set forth above is a specific method of the passage securing unit 60.

That is, the passage securing unit 80 according to the exemplary embodiment preventing the freezing of the beverage around the support member 70 by installing the electrical heater H in the support member 70, but the passage securing unit 80 according to another exemplary embodiment allows the hot water in the hot water storing tank 40 through the hole 74 punched in the support member 70 to flow by branching another pipe line L6 from the pipe line L4 extended from the hot water storing tank 40 to the cock C.

As such, in the case in which the hot water flows through the hole 74 in the support member 70, the freezing of the beverage around the support member 70 may be prevented.

The exemplary embodiments have described in connection with the specific examples of the methods capable of realizing the objects of the present invention. Accordingly, the exemplary embodiments do not limit the claims of the present invention, but all of the technical contents which may be modified through the detailed description and the drawings of the present invention are intended to fall within the scope of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A beverage cooling device comprising:
a beverage storing tank having an inlet through which a new beverage is injected and an outlet through which a cooled beverage is discharged;
a cooling unit cooling a beverage supplied to the beverage storing tank by forming a frozen layer on an inner side wall surface of the beverage storing tank; a beverage flow guide unit provided in the beverage storing tank and increasing cooling efficiency by increasing an area which is in contact with the frozen layer while the beverage injected from the inlet is moved to the outlet; and
a passage securing unit preventing a passage through which the beverage is movable from being blocked by the frozen layer formed to be expanded to the beverage flow guide unit.

2. The beverage cooling device of claim 1, wherein:
the cooling unit includes a compressor compressing a refrigerant into a high temperature and high pressure state, a condenser converting the compressed evaporated refrigerant into a liquefied state, an expansion valve decreasing a pressure of the condensed refrigerant to facilitate evaporation of the condensed refrigerant, and a cooling pipe receiving the refrigerant from the expansion valve to thereby cool the beverage storing tank.

3. The beverage cooling device of claim 1, wherein:
the passage securing unit includes a heating unit heating the beverage flow guide unit.

4. The beverage cooling device of claim 1, wherein:
the beverage flow guide unit includes a support member extended from an upper side of an inner portion of the beverage storing tank to a lower side thereof, and a spiral plate provided in a spiral shape along an outer circumferential surface of the support member.

5. The beverage cooling device of claim 3, wherein:
the heating unit is an electrical heater installed to be inserted into a center of the support member and radiating heat capable of preventing a freezing around the support member.

6. The beverage cooling device of claim 1, wherein:
a beverage temperature sensing sensor sensing a temperature of a beverage in the beverage storing tank is installed in the beverage storing tank to control the passage securing unit.

7. The beverage cooling device of claim 1, wherein:
the passage securing unit does not allow the beverage around the support member to be frozen by supplying a hot water through a hole formed in the support member.

8. A beverage supplying system comprising:
a beverage supplying source;
a filter unit filtering foreign materials which are mixed in a beverage supplied from the beverage supplying source;
a beverage storing tank temporarily storing a beverage supplied from the filter unit; a cooling unit cooling a beverage supplied to the beverage storing tank by forming a frozen layer on an inner side wall surface of the beverage storing tank;
a beverage flow guide unit provided in the beverage storing tank and increasing cooling efficiency by increasing an area which is in contact with the frozen layer while the beverage injected from an inlet is moved to an outlet; and
a passage securing unit preventing a passage through which the beverage is movable from being blocked by the frozen layer formed to be expanded to the beverage flow guide unit.

9. The beverage supplying system of claim 8, wherein:
the passage securing unit includes a support member positioned in the beverage storing tank and having a spiral plate, and an electrical heater embedded in the support member.

10. The beverage supplying system of claim 8, wherein:
the passage securing unit has a hot water storing tank and the support member which are connected with each other by a pipe line to supply a hot water to the support member.
